(19) United States
(12) Patent Application Publication
(10) Pub. No.: US 2005/0269789 A1
(43) Pub. Date: Dec. 8, 2005

(54) Sealing structure by metal gasket

(76) Inventor: Takuma Kameyama, Shizuoka-ken (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/129,117

(22) Filed: May 13, 2005

(30) Foreign Application Priority Data
May 13, 2004 (JP) 2004-143246

(51) Int. Cl. F02F 11/00

(52) U.S. Cl. 277/592

(57) ABSTRACT

A sealing structure includes a gasket that has a passage for a cooling fluid that flows through a cylinder head and cylinder body of an internal combustion engine. The cylinder head and cylinder body are joined together at mating faces. The gasket is made of metallic material and is mounted between the mating faces P. The sealing structure includes an insulating elastic layer that is formed on the surfaces of said metal gasket. The sealing structure also includes a galvanic corrosion inhibitor that is applied to the contact portions of the metal gasket through the insulating elastic layer.

### PRIORITY INFORMATION

This application claims priority to Japanese Patent Application No. 2004-143246, filed May 13, 2004, the entire contents of which is hereby expressly incorporated by reference herein.

### BACKGROUND OF THE INVENTION

1. Field of the Invention

This invention relates to a sealing structure, and, in particular, to a sealing structure for an internal combustion engine.

2. Description of the Related Art

When two different metals are physically or electrically connected and immersed in seawater, a small amount of current flows between the two metals. The electrons that make up that current are supplied by one of the metals, which gives up bits of itself in the form of metal ions to the seawater. This process is called galvanic corrosion and, left unchecked; it can quickly destroy underwater metals.

Accordingly, various methods and devices have been developed to seal an interface between two metallic components that are coupled together. For example, for the purpose of inhibiting clearance corrosion between pipe flange faces exposed to seawater, a rubber packing containing a zinc powder paste can be mounted between the pipe flange faces. In a similar method, a zinc-base anti-corrosive paste can be applied to the faces. The zinc acts as a sacrificial anode protecting the metallic components.

With respect to engines used in marine environments (e.g., an outboard motor), the engine of a watercraft, which travels on the sea, uses seawater as a coolant. The seawater is circulated through cooling water passages formed in the engine to the engine parts that need cooling. This creates a problem as corrosion can occur in the clearance gaps that exist between the mating faces of various parts of the engine (e.g., between a cylinder body and cylinder head).

In some marine environments, the engine is made an aluminum alloy and a metal gasket comprising a stainless steel plate is mounted between the mating faces of the engine. This can result galvanic corrosion. In addition, in such applications, the metal gasket often needs to be machined with high accuracy to the shape of the engine and positioned accurately across the cooling water passages in the mounting faces in order to seal the cooling water passages. Therefore, such gaskets have strict machining and assembling requirements. Moreover, these gaskets must be sufficiently rugged to meet high temperature, anti-corrosion and stable sealing requirements.

Thus, a need exists for an improved sealing structure that can be used to seal various interfaces in an engine. Advantageously, the sealing structure is also useful in marine environments in which the sealing structure is exposed to saltwater.

### SUMMARY OF THE INVENTION

To inhibit corrosion of an engine with a metal gasket, a conventional rubber packing can be mounted simply on the mating face. In another application, an anticorrosive paste is applied on the mating face. However, in such an arrangement, reliable sealing can be compromised, for example, when removal of grease or dirt on the mating faces is insufficient and when there is irregular fastening forces of the packing and/or uneven application of the paste.

Patent Document JP-A-Hei 6-11042 discloses a cylinder head gasket mounted between mating faces of the cylinder head and the cylinder body of an engine. The gasket is provided with a metallic core having an electrolyte potential approximately equal to that of the cylinder head and cylinder body. The gasket disclosed in this patent document seeks to inhibit corrosion of the engine due to the galvanic corrosion effects by providing an aluminum core provided with aluminum surface layer on both upper and lower sides. However, the cylinder gasket disclosed in Patent Document JP-A-Hei 6-11042 has a particularly complicated structure comprising three layers and is difficult to manufacture. In addition, the gasket should be manufactured of the same kind of aluminum material as the members of the engine to be protected. Thus, to achieve the electrolytic effects due to matching in the electrolyte potential, existing gaskets of stainless steel are useless.

An aspect of the present invention involves providing a sealing structure through the use of a metal gasket that is capable (i) of meeting strict manufacturing, assembling and functional requirements necessary for a gasket, (ii) of securing a stable and reliable sealing property using a metal gasket with an electrolyte potential different from that of members of the engine to be protected, and/or (iii) of inhibiting corrosion of an engine.

As such, in accordance with one aspect of the present invention, a sealing structure is provided for mounting between mating faces of two members of an internal combustion engine. The sealing structure includes a metal gasket that comprises at least one passage for a fluid that flows through the two members of the engine. An insulating elastic layer is formed on an outer surface of the metal gasket. A galvanic corrosion inhibitor is applied to the elastic layer at least one or more portions of the metal gasket that contact the two members.

Another aspect of the present invention comprises a sealing structure for sealing an interface between two members of an engine of an outboard motor. The sealing structure comprises a metal gasket that includes at least one opening for the passage of fluid through the sealing structure. The sealing structure also includes means for inhibiting the corrosion of the outboard motor about the opening.

### BRIEF DESCRIPTION OF THE DRAWINGS

These and other features, aspects and advantages of the present invention are described below with reference to the drawings of several preferred embodiments, which are intended to illustrate and not to limit the invention. The drawings comprise four figures.

FIG. 1 is a side elevational view of an outboard motor configured in accordance with a preferred embodiment of the present invention. An engine and drive train of the motor are illustrated in phantom.

FIG. 2 is a cross-sectional view of the engine of the outboard motor of FIG. 1.

FIG. 3A is a top plan view of a gasket of the cylinder block of the engine of FIG. 2.

FIG. 3B is a cross-sectional view taken through line B-B of FIG. 3A.

### DETAILED DESCRIPTION OF THE PREFERRED EMBODIMENTS

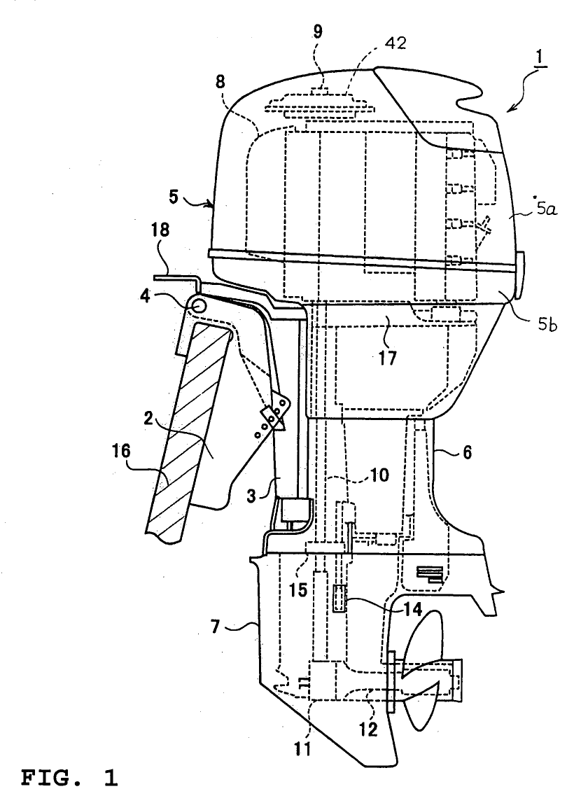

FIG. 1 is a side elevational view of an outboard motor 1 configured in accordance with a preferred embodiment of the present invention. An engine and drive train of the motor are illustrated in phantom.

As will be described in more detail below, certain embodiments of a sealing structure have particular utility in the context of a marine drive, such as an outboard motor, and thus the sealing structure is described in the context of an outboard motor. However, it should be appreciated that the sealing structure can be used with other types of marine drives (i.e., inboard motors, inboard/outboard motors, jet drives, etc.) and also certain land vehicles. Furthermore, the sealing structure can be used in a stationary engine for some applications as will be apparent to those of ordinary skill in the art in light of the description herein.

With reference now to FIG. 1, the outboard motor 1 is coupled to a transom plate 16 of a hull through a clamping bracket 2. The outboard motor 1 is rotatable about a tilting shaft 4 and can be lifted upward when not in use. In addition, the tiling shaft can be used to adjust the trim angle during running. The outboard motor 1 is held by a swiveling bracket 3 and rotated about an approximately vertical swiveling shaft (not shown) through a shift link 18. Thus, the driver controls the direction of the boat by rotating the motor 1 about the vertical shaft.

The outboard motor 1 is covered externally with a cowling 5 formed of a top cowl 5a and a bottom cowl 5b. An upper case 6 is connected to the cowling 5 at the lower side. A lower case 7, in turn, extends below the upper case 7.

With continued reference to FIG. 1, within the cowling 5 is an engine 8. The engine 8 is positioned on an exhaust guide 17. The engine 8 is, for example, a water-cooled, four-cylinder, four-stroke engine having a vertically-disposed crankshaft 9 and a drive shaft 10 that is connected to the lower end of the crankshaft 9. The lower end of the drive shaft 10 is, in turn, connected to a propeller shaft 12 through an advancing and reversing switch mechanism 11. An inlet 14 for seawater as cooling water is positioned on the side of the lower case 7. Seawater, taken in from the inlet 14, is increased in pressure by a cooling water pump 15 connected to the drive shaft 10, and sent to the engine 8 to cool regions around combustion chambers and exhaust passages, or other engine parts.

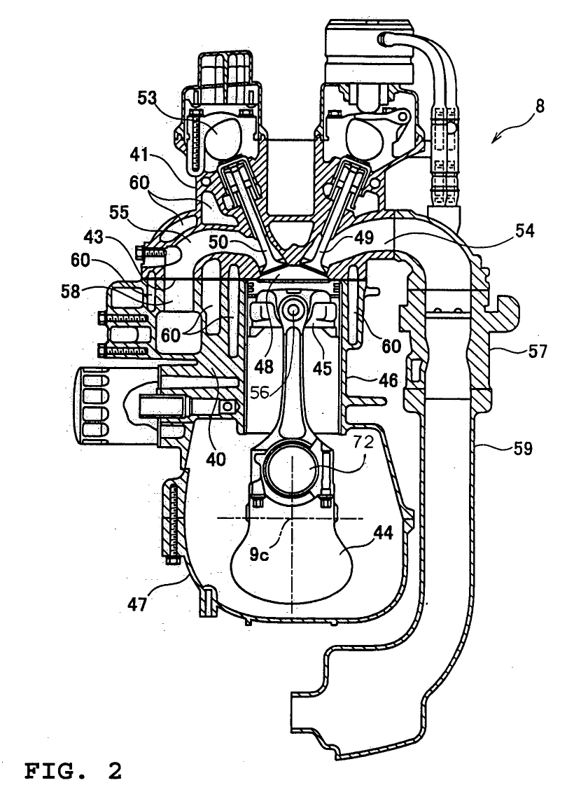

FIG. 2 is a sectional view in the vertical direction to the crankshaft 10 of the engine 8. As mentioned above, in the illustrated embodiment, the engine 8 is a water-cooled, four-stroke and, for example, four-cylinder engine. This type of engine, however, merely exemplifies one type of engine on which various aspects and features of the present invention can be suitably used. Engines operating on other combustion cycles, having a different numbers of cylinders (e.g., 1 cylinder, two cylinders or six cylinder) and/or having other cylinder arrangements (V, W, opposing, etc.) also can employ various features, aspects and advantages of the present invention. In addition, the engine can be formed with separate cylinder bodies rather than a number of cylinder bores formed in a cylinder block.

The axis 9c of the crank webs 44 of the four cylinders is disposed vertically (when the crankshaft 10 is in the vertical direction in a running state). A flywheel 42 (FIG. 1) is mounted to the upper end of the crankshaft 10 and constitutes a generator. The drive shaft 10 (FIG. 1) is connected to the lower end of the fly wheel 42.

As shown in FIG. 2, in the illustrated embodiment, the engine 8 comprises a cylinder body 40 and a cylinder head 41 that is made, for example, of a casting of an aluminum alloy. The body 40 and head 41 are joined together, with a metal gasket 43 placed between the mating faces of the body 40 and head 41. The cylinder body 40 comprises cylinders 46. Within each cylinder 46 is a piston 45 configured to slide therein. A crankcase 47 containing the crank webs 44 is positioned beneath the cylinders 46. Each piston 45 is connected to the crankshaft 10 through a piston pin 56 and a crank pin 72. The cylinder head 41 is formed with a combustion chamber 48 at the top of each of the cylinders 46. An intake port 54 and an exhaust port 55 are formed facing each combustion chamber 48, and an intake valve 49 and an exhaust valve 50 are provided in these ports, respectively. A carburetor 57 is mounted in the intake pipe 59 in communication with the intake port 54. An exhaust passage 58 is formed in communication with the exhaust port 55. Reference numeral 53 designates a cam positioned on a cam shaft.

With continued reference to FIG. 2, a cooling water passage (or cooling water jacket) 60 extends in the regions around the combustion chambers 48, around the cylinders 46 and around the exhaust passages 58. Cooling water (e.g., seawater) is circulated by the cooling water pump 15 (see FIG. 1) through the cooling water passage 60. The metal gasket 43 is provided between the mating faces of the cylinder head 41 and the cylinder body 40. The metal gasket 43 crosses the cooling water passage 60 and is exposed to the inside of this passage. Thus, in some embodiments, the gasket 43 is exposed to seawater.

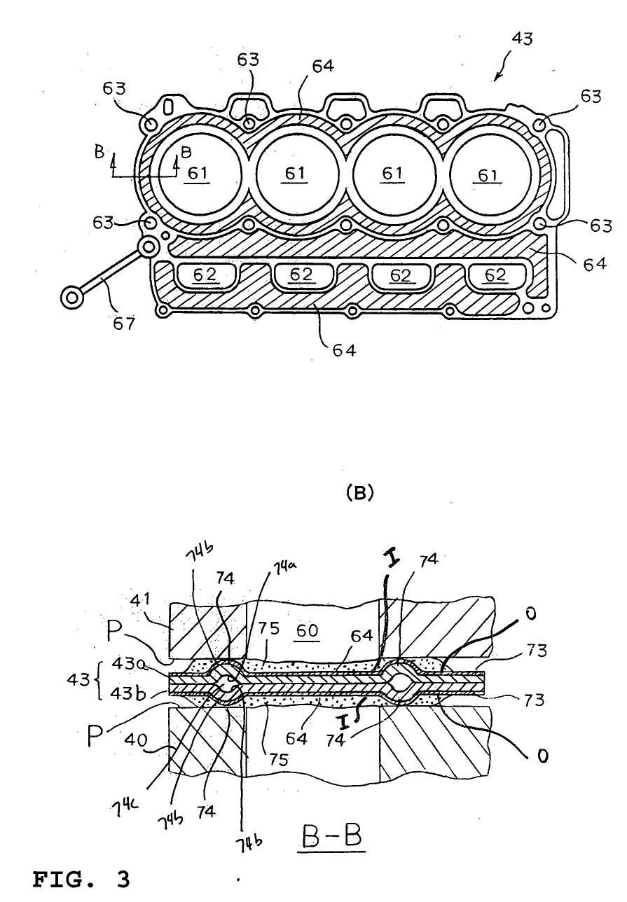

FIG. 3A is a top plan view of a metal gasket according to an embodiment of the present invention. FIG. 3B is an enlarged cross-section along the line B-B of FIG. 3A.

As shown in FIGS. 3A and 3B, the metal gasket 43 is formed with openings 61 corresponding to the four cylinders, openings 62 corresponding to the exhaust passages 58 (FIG. 2), and other openings (not shown) for communication between the upper and lower cooling passages of the engine. In the illustrated embodiment, at ten locations around the openings 61 of the four cylinders 46 are formed through-holes 63 for head bolts or other fasteners for connecting the cylinder body 40 and the cylinder head 41. Around the openings 61, 62 of the cylinders 46 and exhaust passages 58 in the metal gasket 43 are formed cooling water passages 64 (indicated by cross-hatching), which correspond to the cooling water passages 60 in the cylinder head 41 and the cylinder body 40 shown in FIG. 2. In this manner, cooling water can flow from the cylinder body 40, through the gasket 43 and into the cylinder head 41 and/or vice versa. Reference numeral 67 designates an electric cord.

The metal gasket 43, as shown in FIG. 3B, is held by the cylinder body 40 and the cylinder head 41 between their mating faces P. In the illustrated embodiment, the metal gasket 43 is formed of two stainless steel plates 43a, 43b joined together. The surface of each of the steel plates 43a, 43b is coated with an insulating elastic layer 73, which can comprise rubber or another resinous material. In addition, each of the steel plates 43a, 43b is preferably formed with ridges or beads 74 protruding along the cooling water passage 60 on both sides thereof. The two steel plates 43a, 43b are joined together, with their beads 74 aligned to each other. As shown in FIG. 3B, the ridge or bead of the illustrated embodiment comprises forming an indentation 74a on one side of the plate 43a, 43b, which forms a protrusion 74b on a second side of the plate. The indentations 74a are aligned with each other to form a gap 74c with the protrusions 74b generally facing the mating faces P. As will be explained below, those of skill in the art will recognize various other types configurations for forming the ridge or beads 74 including, but not limited to, adding additional material to the plates 43a, 43b.

Between the two rows of beads 74 on each of the upper and lower surfaces of the metal gasket 43 is formed the cooling water passage 64, which extends through the gasket 43 and corresponds to the cooling water passage 60. A galvanic corrosion inhibitor 75 is applied to these upper and lower surfaces along the cooling water passages 64. In one embodiment, the galvanic corrosion inhibitor 75 is a paste sealing material composed of, for example, a synthetic resin polymer as a base material and Zn particulates dispersed in an HC-base or another type solvent having a sticking property or adhesive nature. In a modified embodiment, a liquid paint containing dispersed Zn particulates can be used. In another embodiment, an adhesive sealing tape having a coating layer containing the foregoing Zn particulates on the bonding surface can be used.

The galvanic corrosion inhibitor 75 is preferably applied to both of the upper and lower surfaces of the metal gasket 43 along the cooling water passages 64. In this case, because the coolant (e.g., seawater) flows in the region of the cooling water passage 60 between both beads 74, corrosion of the cylinder head 41 and the cylinder body 40 can be advantageously prevented or significantly reduced if the galvanic corrosion inhibitor 75 is applied only to the inner portion I of the metal gasket 43 between two rows of beads 74 (on the water passage 60 side), preferably, at least along both edges of the cooling water passage 64. However, in the illustration, for the purpose of improving efficiency of application and increasing the amount of Zn to prolong durability of the galvanic corrosion effects, the galvanic corrosion inhibitor 75 is applied to the entire surface of the gasket 43 along the cooling water passage 64 and portions O outside the beads 74.

Because layers of such galvanic corrosion inhibitor 75 are provided on the metal gasket 43 through the rubber layers 73, the Zn particulates act as a sacrificial anode, inhibiting galvanic corrosion, due to seawater, of the members to be protected (e.g., bolts and other components of the engine) by the gasket 43 and/or the cylinder head 41 and the cylinder body 40 formed of an aluminum alloy. As a result, leakage of seawater from the cooling water passage 60 is inhibited reliably and reliability of the sealing structure by the metal gasket 43 is enhanced. In addition, the galvanic corrosion inhibition effects on the protected members can be secured.

If the galvanic corrosion inhibitor 75 has a sticking property (or adhesive nature), it advantageously sticks to the protected members in contact therewith reliably, so that the sealing property to the protected members is improved and the galvanic corrosion prevention effects can be achieved reliably. This arrangement also enhances prevention of the leakage of seawater as well as the inhibition of galvanic corrosion due to leakage of seawater outside the cooling water passage 64.

The configuration of the metal gasket 43 is not limited to the illustrated embodiment, in which, as an example, two plates are joined together. For example, in a modified embodiment, the gasket 43 can be formed of one plate (e.g., a steel plate). In such an embodiment, the upper and lower surfaces of a steel plate can be coated with rubber layers. In another embodiment, two steel plates may be joined together, with projections in abutment against each other. The bead in such an embodiment can be formed in a stepped shape. In this embodiment, if the two steel plates are joined together, the spacing between the steel plates can become wider at both ends.

As mentioned above, the gasket 43 is particularly applicable as a sealing structure for inhibiting corrosion of metallic parts in an engine or a hull of a watercraft that travels on the sea.

In the illustrated embodiment, a galvanic corrosion inhibitor 75 is applied to the metal gasket 43 through an insulating elastic layer 73. This galvanic corrosion inhibitor 75 advantageously conducts electricity to the protected members to inhibit their galvanic corrosion. Therefore, because the gasket 43 is electrically insulated from the galvanic corrosion inhibitor 75, even when the metal of the metal gasket 43 is larger in electrolytic action to the galvanic corrosion inhibitor than the protected members, corrosion of the protected members due to electrolytic action can be inhibited sufficiently and reliably. This allows prevention of galvanic corrosion of the protected members along the passage of the corrosive fluid and a stable and reliable sealing function can be maintained without impairing sealing action by the metal gasket 43. In the illustrated embodiment, even if the metal surface of the metal gasket 43 or the surface of the protected member has fine cracks or irregularities, they are elastically absorbed by the insulating elastic layer 73 on the surface of the metal gasket 43 and a reliable sealing function can be achieved.

Another advantage of the illustrated embodiment, is that the sacrificial anode effects of zinc due to electrolytic action allow an aluminum alloy engine to be protected effectively from galvanic corrosion due to seawater. Therefore, in an engine for a watercraft using seawater as cooling water, corrosion can be effectively inhibited or prevented with an existing metal gasket of steel plate.

Another advantage of the illustrated embodiment is that because the metal gasket 43 is formed with beads 74 protruding along the cooling water path (passage 60) on both sides thereof, the passage 64 is formed reliably and sealing can be effected along the passage 64. In addition, because the galvanic corrosion inhibitor 75 is applied to the metal gasket 43 at the inner portion I between both beads 74, that is, on the passage 60 side, galvanic corrosion of engine members due to seawater flowing in the passage is inhibited or prevented, securing the sealing property of the bead section stably.

Another advantage of the illustrated embodiment is that the galvanic corrosion inhibitor 75 has a sticking property. This enhances the sealing property of the passage 64. Leakage of corrosive fluid is inhibited or prevented reliably, inhibiting galvanic corrosion of protected member s more reliably.

Certain objects and advantages of the invention have been described above for the purpose of describing the invention and the advantages achieved over the prior art. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combine with or substituted for one another in order to form varying modes of the disclosed invention. Thus, it is intended that the scope of the present invention herein disclosed should not be limited by the particular disclosed embodiments described above, but should be determined only by a fair reading of the claims that follow

1. A sealing structure for mounting between mating faces of two members of an internal combustion engine, comprising
a metal gasket that includes at least one passage for a fluid that flows through the two members of the engine;
an insulating elastic layer formed on an outer surface of the metal gasket, and
a galvanic corrosion inhibitor that is applied to the elastic layer at least one or more portions of the metal gasket that contact at least one of the two members.

2. The sealing structure as in claim 1, wherein the two members comprise a cylinder head and a cylinder body that are made of an aluminum alloy.

3. The sealing structure as in claim 1, the metal gasket comprises a steel material.

4. The sealing structure as in claim 1, wherein the galvanic corrosion inhibitor comprises zinc.

5. The sealing structure as in claim 1, wherein the metal gasket comprises a ridge that circumscribes the at least one passage for the fluid.

6. The sealing structure as in claim 5, wherein the metal gasket comprises a first plate and a second plate and the ridge is formed by indentation and corresponding protrusion formed on each plate, the first and second plate being arranged such that the indentations face each other.

7. The sealing structure as in claim 5, wherein the galvanic corrosion inhibitor is applied to the metal gasket on a portion of the gasket circumscribed by the ridge.

8. The sealing structure as in claim 7, wherein the galvanic corrosion inhibitor is also applied to the metal gasket on a portion of the gasket outside the ridge.

9. The sealing structure as in claim 5, wherein the galvanic corrosion inhibitor is applied to the metal gasket only on a portion of the gasket circumscribed by the ridge.

10. The sealing structure as in claim 1, wherein the galvanic corrosion inhibitor has an adhesive nature.

11. The sealing structure as in claim 1, wherein the galvanic corrosion inhibitor comprises zinc particulate.

12. The sealing structure as in claim 1, wherein the galvanic corrosion inhibitor comprises a paste that comprises a synthetic resin polymer base material and zinc particles dispersed in a solvent.

13. The sealing structure as in claim 1, wherein the galvanic corrosion inhibitor comprises a liquid paint comprising dispersed zinc particulates.

14. The sealing structure as in claim 1, wherein the galvanic corrosion inhibitor comprises an adhesive sealing tape having a coating of zinc particulates.

15. The sealing structure as in claim 1, wherein the insulating elastic layer comprises a resinous material.

16. The sealing structure as in claim 1, wherein the insulating elastic layer comprises rubber.

17. The sealing structure as in claim 1, wherein the metal gasket comprises a first plate of metallic material joined together with a second plate of metallic material.

18. The sealing structure as in claim 1, wherein the metal gasket comprises stainless steel.

19. The sealing structure as in claim 1, in combination with an outboard motor engine in which the first member is a cylinder body and the second member is a cylinder head, the outboard motor including a cooling water pump configured to delivery walter to cooling passages in the engine and through said at least one passage for a fluid.

20. The sealing structure as in claim 1, wherein the at least one passage is a cooling water passage.

21. The sealing structure as in claim 1, wherein the metal gasket contacts wherein the galvanic corrosion inhibitor is applied to the elastic layers at portions of the metal gasket that contact the two members.

22. A sealing structure for sealing an interface between two members of an engine of an outboard motor, comprising:
a metallic gasket comprising at least one opening for the passage of fluid through the sealing structure; and
means for inhibiting corrosion of the outboard motor about the opening.

23. The sealing structure as in claim 22, wherein the metallic gasket comprises steel.

24. The sealing structure as in claim 22, wherein the metal gasket comprises a ridge that circumscribes the at least one opening.

25. The sealing structure as in claim 22, wherein the metal gasket comprises a first plate of metallic material joined together with a second plate of metallic material.
